(19) United States
(12) Patent Application Publication
(10) Pub. No.: US 2014/0367441 A1
(43) Pub. Date: Dec. 18, 2014

(54) COMBUSTION-TYPE POWER TOOL

(71) Applicant: Basso Industry Corporation, Taichung (TW)

(72) Inventors: An-Gi Liu, Taichung (TW); Wen-Liang Li, Taichung (TW); Chang-Sheng Lin, Taichung (TW); Fu-Ying Huang, Taichung (TW)

(21) Appl. No.: 14/303,920

(22) Filed: Jun. 13, 2014

(30) Foreign Application Priority Data
Jun. 18, 2013 (TW) 102121524

(51) Int. Cl. B25C 1/08; B25C 1/00

(52) U.S. Cl. CPC B25C 1/08; B25C 1/008
USPC 227/8

(57) ABSTRACT

In a combustion-type power tool, when a safety unit is pressed against a workpiece to cause a valve sleeve to close a combustion chamber, a power region of a lever is actuated to permit a weight region of the lever to displace a holding member holding a fuel canister from a normal position to a pressed position. When the holding member is in the pressed position, a valve stem of the fuel canister is forced into pressing engagement with an intake port of a fuel canister actuation unit to permit delivery of a measured dose of fuel to the combustion chamber through the intake port.

### CROSS-REFERENCE TO RELATED APPLICATION

This application claims priority from Taiwanese application no. 102121524, filed on Jun. 18, 2013, the disclosure of which is incorporated in its entirety herein by reference.

### BACKGROUND OF THE INVENTION

1. Field of the Invention

This invention relates to a combustion-type power tool, more particularly to a combustion-type power tool which can be operated in a force-saving manner.

2. Description of the Related Art

As shown in FIGS. 1 and 2, a setting tool 1 disclosed in US patent application publication no. 20060022013 includes a body 11 having a nose end 111 and a head end 112, a safety unit 121 extending outwardly of the body 11, a fuel canister 13, and a canister seat 122 on which the fuel canister 13 is placed. The canister seat 122 is coupled to the safety unit 121 to move therewith. When the safety unit 121 is pressed against a workpiece (not shown), it retracts and moves toward the head end 112 to thereby move the canister seat 122 and thus the fuel canister 13 toward the head end 112, causing the fuel canister 13 to deliver a measured dose of fuel to a combustion chamber 10. Since the fuel canister 13 is heavy, a relatively large force is needed to press the safety unit 121 against the workpiece to thereby move the fuel canister 13.

U.S. Pat. No. 7,654,429 discloses a combustion nailer which includes a tool housing having a combustion chamber and a fuel cell chamber, a workpiece contact element, a fuel cell disposed in the fuel cell chamber, and a fuel cell actuator assembly which includes an actuator element and a pivot member that are pivotally mounted to the tool housing. When the workpiece contact element is pressed against a workpiece to initiate pivoting movement of the pivot member for axially depress the actuator element, an axial depressing force is exerted on a fuel cell stem of the fuel cell to cause the fuel cell stem to dispense a measured dose of fuel to the combustion chamber. However, since the axial force is exerted on the fuel cell stem as a result of angular pivoting movement of the actuator element, the axial depressing force may not be exerted precisely on the fuel cell stem.

### SUMMARY OF THE INVENTION

Therefore, an object of the present invention is to provide a combustion-type power tool that can overcome the aforesaid drawbacks of the prior art, particularly, a combustion-type power tool that can be operated in a force-saving manner to cause a fuel canister to dispense a measured dose of fuel.

According to this invention, a combustion-type power tool is for use with a fuel canister which extends along a lengthwise axis to terminate at a bottom end and a top end, and which has a valve stem that extends along the lengthwise axis and that is movable relative to the top end between a dispensing position, where a measured dose of fuel is dispensed, and a non-dispensing position. The combustion-type power tool includes a housing body, a cylinder, a valve sleeve, a safety unit, a holding member, a fuel canister, a fuel canister actuator unit, and a lever unit. The housing body defines a main chamber which extends in a longitudinal direction to terminate at a nose end and a head end. The cylinder is disposed in the main chamber, has a cylinder axis in the longitudinal direction, and defines a combustion chamber. The valve sleeve is sleeved on the cylinder and is movable relative to the cylinder between an open position, where the combustion chamber is opened, and a close position, where the combustion chamber is closed. The valve sleeve has a nose-side end and a head-side end. The safety unit is configured to be coupled to and moved with the valve sleeve such that when the safety unit is pressed against a workpiece to move from an extended position to a retracted position, the valve sleeve is displaced from the open position to the close position. The holding member defines a central axis parallel to the cylinder axis, and has a base oriented normal to the central axis. The holding member is disposed proximate to the nose-side end and is movable relative to the cylinder between a normal position, where the base is remote from the head end, and a pressed position, where the base is close to the head end. The base is adapted for detachable placement of the fuel canister thereon with the lengthwise axis in line with the central axis such that when the holding member is displaced from the normal position to the pressed position, the valve stem is displaced from the non-dispensing position to the dispensing position. The fuel canister actuator unit includes a pivoted end pivotally mounted to the housing body proximate to the head end, and an intake end which has an intake port defining a port axis and which is angularly movable between a ready position, where the port axis is in line with the lengthwise axis so as to permit the intake port to be brought into pressing engagement with the valve stem to place the valve stem in the dispensing position, and a clear position, where the fuel canister is removable from or placeable on the base. The lever unit includes at least one lever having a power region and a weight region. The lever unit is disposed such that the power region is actuated by displacement of the valve sleeve from the open position toward the close position to permit the weight region to displace the holding member from the normal position to the pressed position so as to force the valve stem into pressing engagement with the intake port, thereby permitting the measured dose of fuel to be delivered to the combustion chamber through the intake port.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a partially sectioned view of a setting tool disclosed in US patent application publication no. 20060022013;

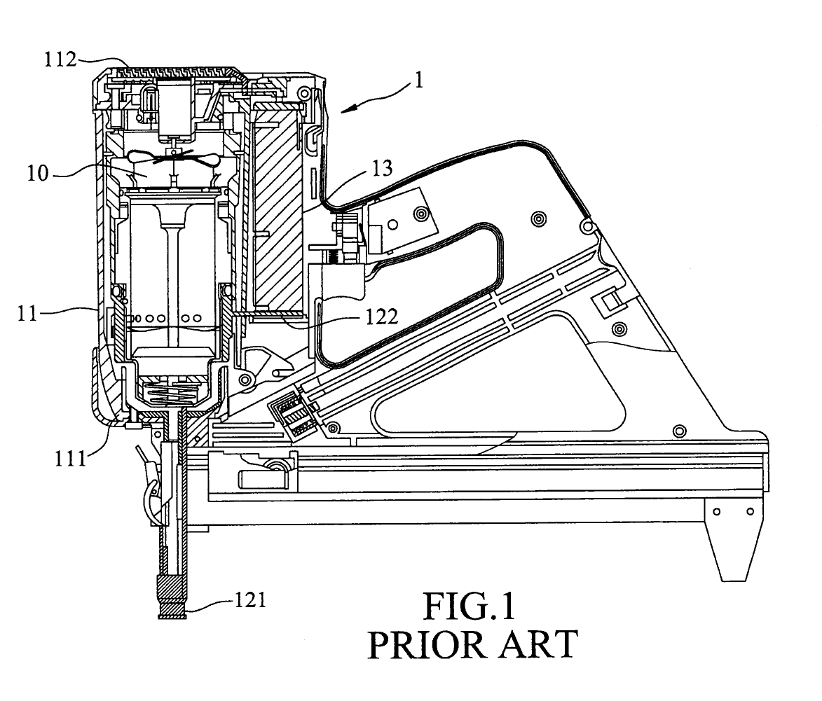

FIG. 2 shows some of the elements of the setting tool of FIG. 1;

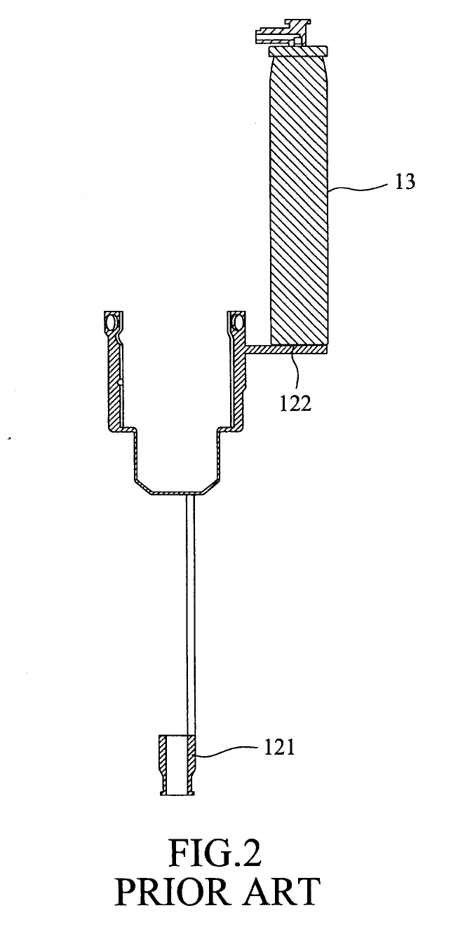

FIG. 3 is a perspective view of a combustion-type power tool according to a preferred embodiment of this invention, some elements being omitted;

FIG. 4 is a fragmentary partly sectional view of the combustion-type power tool;

FIG. 5 is a schematic perspective view the combustion-type power tool in part;

FIG. 6 is a side view showing the combustion-type power tool in part and a holding member in a normal position; and

FIG. 7 is a side view similar to FIG. 6, but showing the holding member in a pressed position.

### DETAILED DESCRIPTION OF THE PREFERRED EMBODIMENT

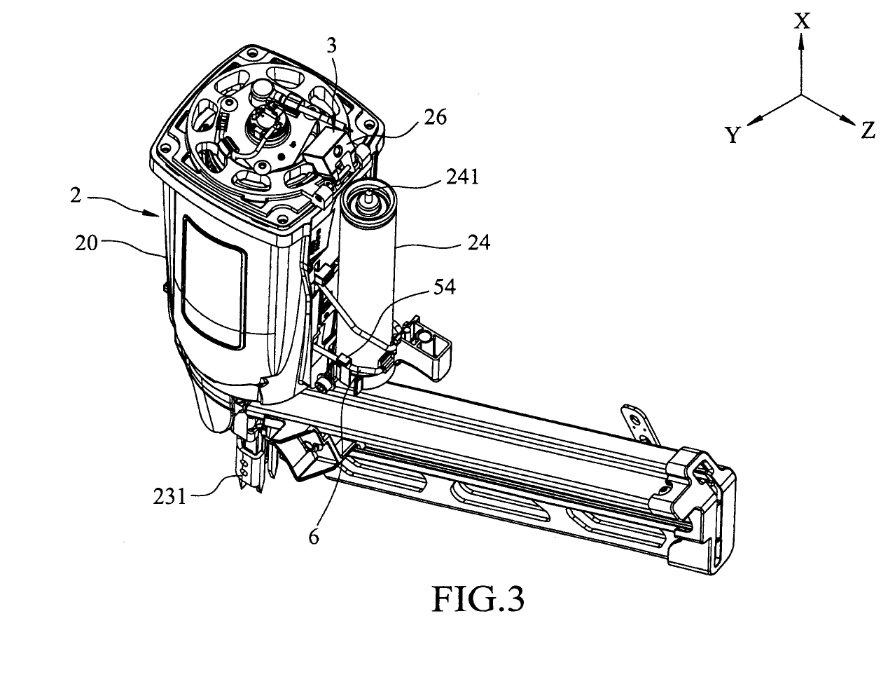

FIGS. 3 to 7 show a combustion-type power tool 2 according to a preferred embodiment of this invention, which includes a housing body 20, a cylinder 21, a valve sleeve 22, a safety unit 231, a holding member 5, a fuel canister actuator unit 26, and a lever unit 6.

The combustion-type power tool 2 is for use with a fuel canister 24 which extends along a lengthwise axis (C) to terminate at a bottom end 242 and a top end 243, and which has a valve stem 241 that extends along the lengthwise axis (C) and that is movable relative to the top end 243 between a dispensing position, where a measured dose of fuel is dispensed, and a non-dispensing position. The valve stem 241 is biased to the non-dispensing position.

The housing body 20 defines a main chamber 201 and a canister chamber 25. The main chamber 201 extends in a longitudinal direction (X) to terminate at a nose end 202 and a head end 203. The canister camber 25 extends in the longitudinal direction (X) for receiving the fuel canister 24.

The cylinder 21 is disposed in the main chamber 201, has a cylinder axis (A) in the longitudinal direction (X), and defines a combustion chamber 210.

The valve sleeve 22 is sleeved on the cylinder 21 and is movable relative to the cylinder 21 between an open position, where the combustion chamber 210 is opened, and a close position, where the combustion chamber 210 is closed. The valve sleeve 22 has a nose-side end 221 and a head-side end 222. Once the valve sleeve 22 is displaced from the open position to the close position, a trigger 7 of the combustion-type power tool 2 is operable to ignite fuel in the combustion chamber 210.

The safety unit 231 is disposed downwardly of the nose end 202 and is configured to be coupled to and moved with the valve sleeve 22 such that when the safety unit 231 is pressed against a workpiece (W) to move from an extended position to a retracted position, the valve sleeve 22 is displaced from the open position to the close position. The safety unit 231 is biased to the extended position by a spring member (not shown).

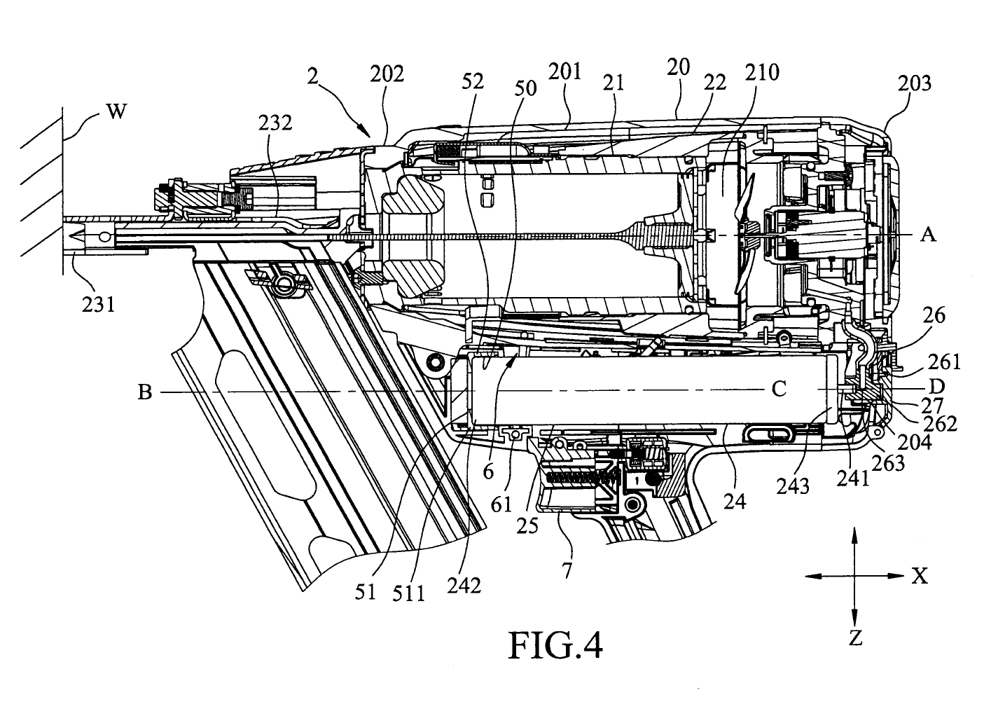

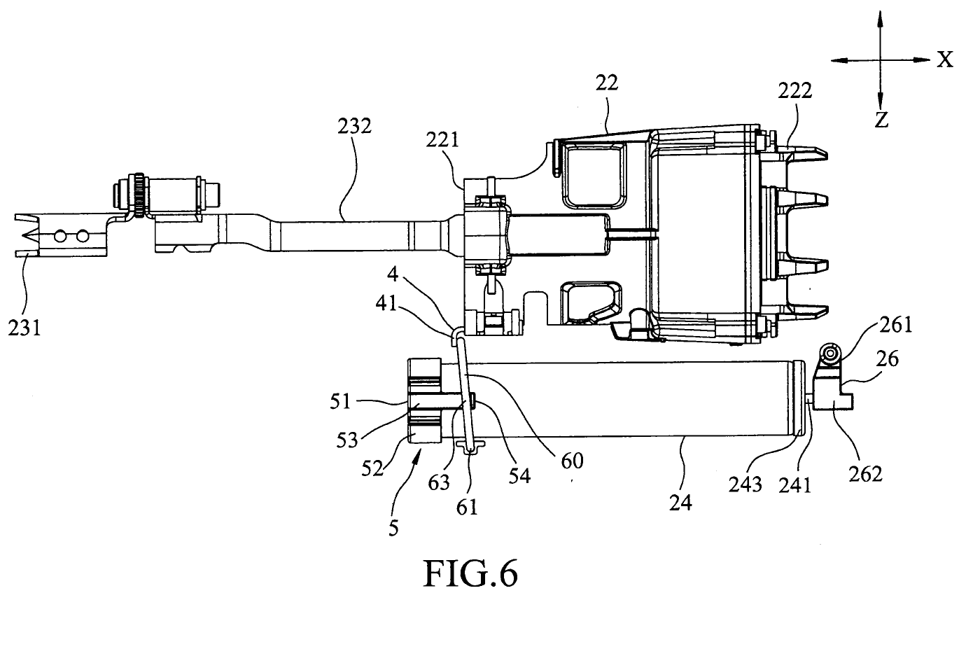

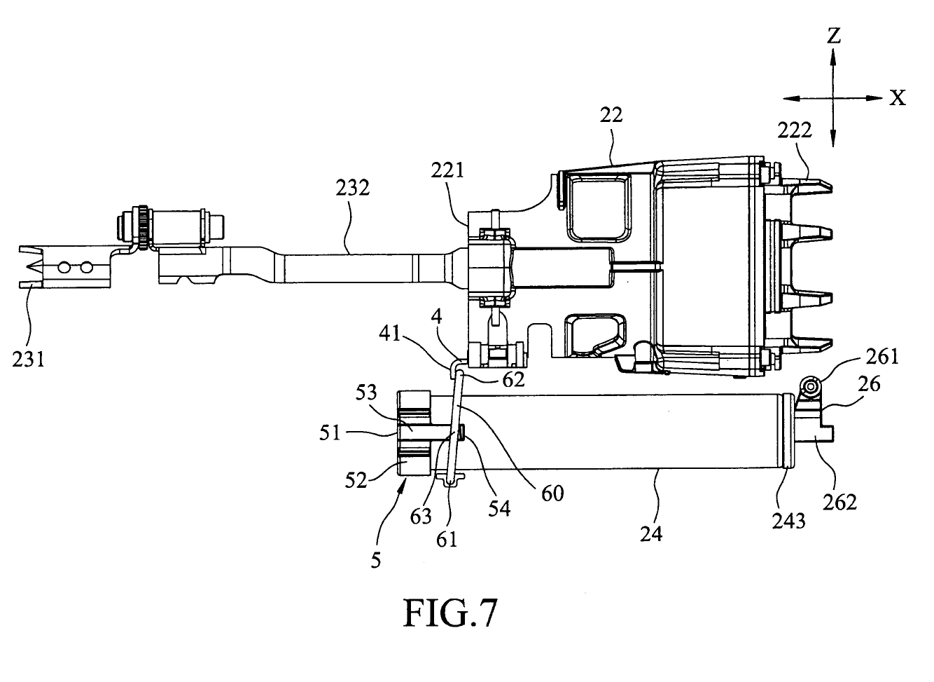

The holding member 5 is received in the canister chamber 25, and is configured to hold the fuel canister 24. The holding member 5 defines a central axis (B) substantially parallel to the cylinder axis (A), and has a base 51 which has a periphery 511 and which extends in a plane normal to the central axis (B), that is, the base 51 is oriented normal to the central axis (B). The holding member 5 is disposed proximate to the nose-side end 221, and is movable relative to the cylinder 21 between a normal position (see FIGS. 4 and 6), where the base 51 is remote from the head end 203, and a pressed position (see FIGS. 4 and 7), where the base 51 is close to the head end 203. The fuel canister 24 is detachably placed on the base 51 with the lengthwise axis (C) in line with the central axis (B). When the holding member 5 is displaced from the normal position to the pressed position, the valve stem 241 is displaced from the non-dispensing position to the dispensing position.

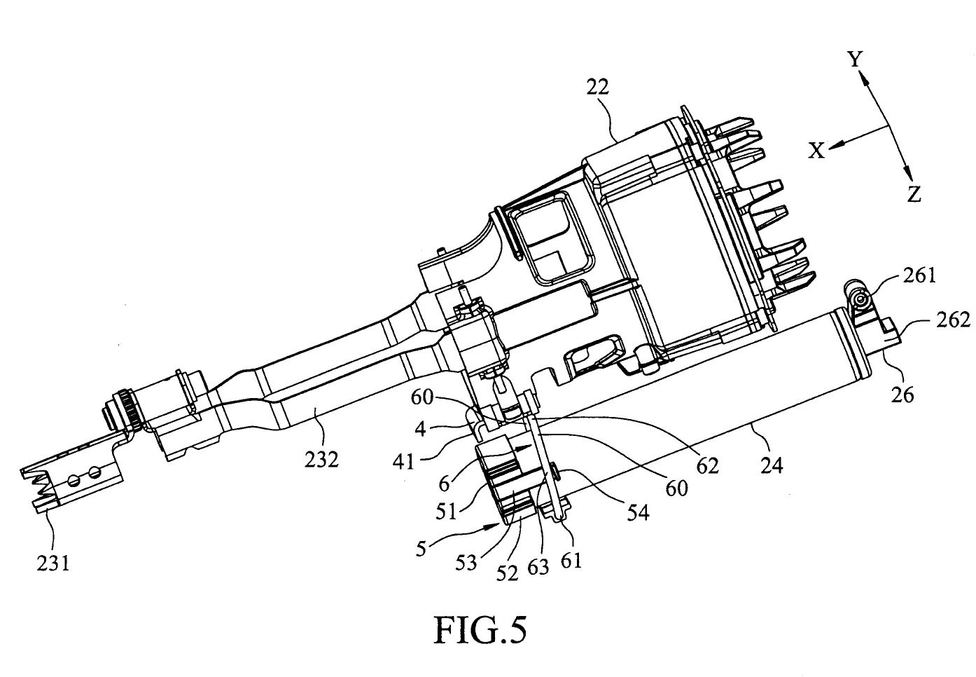

In this embodiment, the holding member 5 further has a tubular wall 52 and two arms 53 (only one is visible in FIGS. 5 to 7). The tubular wall 52 extends upwardly from the periphery 511 of the base 51, and the base 51 and the tubular wall 52 cooperatively define a socket cavity 50 configured to receive the fuel canister 24 fittingly therein. The arms 53 extend respectively from opposite sides of the base 51 to terminate respectively at two actuated ends 54. Each of the actuated ends 54 is disposed upwardly of the tubular wall 52.

The fuel canister actuator unit 26 includes a pivoted end 261 pivotally mounted to the housing body 20 proximate to the head end 203, and an intake end 262 which has an intake port 263 defining a port axis (D) and which is angularly movable between a ready position, where the port axis (D) is in line with the lengthwise axis (C) so as to permit the intake port 263 to be brought into pressing engagement with the valve stem 241 to thereby place the valve stem 241 in the dispensing position, and a clear position, where the fuel canister 24 can be removed from or placed on the base 51.

The lever unit 6 is disposed in the canister chamber 25 and pivotally connected to the housing body 20. The lever unit 6 includes a pair of levers 60 disposed at the opposite sides of the fuel canister 24 in terms of the central axis (B). Each of the levers 60 has a power region 62 and a weight region 63, and the power regions 62 of the levers 60 are actuated by displacement of the valve sleeve 22 from the open position toward the close position to permit the weight regions 63 of the levers 60 to displace the holding member 5 from the normal position to the pressed position so as to force the valve stem 241 into pressing engagement with the intake port 263, thereby permitting the measured dose of fuel to be delivered to the combustion chamber 210 through the intake port 263.

In this embodiment, each of the actuated ends 54 is actuated by the weight region 63 of a corresponding one of the levers 60 so as to permit movement of the holding member 5 from the normal position to the pressed position.

In this embodiment, each of the levers 6 extends lengthwise to terminate at a sleeve-side end 62 which serves as the power region 62, and a fulcrum end 61 which is pivotally mounted to the housing body 20. As shown in FIGS. 5 to 7, because the weight region 63 for exerting a force on the holding member 5 is disposed between the sleeve-side end 62 (the power region 62) and the fulcrum end 61, the fuel canister 24 on the holding member 5 can be moved to the dispensing position in a force-saving manner.

Preferably, the housing body 20 is formed with an access opening 204 for providing access to the fuel canister actuator unit 26. The combustion-type power tool 2 further includes a fuel canister door 27 which is pivotally mounted to the housing body 20 and is angularly movable between a locked position, where the access opening 204 is closed by the fuel canister door 27, and an unlocked position. The fuel canister door 27 is configured such that in the locked position, the fuel canister door 27 is brought into pressing engagement with the fuel canister actuator unit 26 to thereby prevent movement of the intake end 262 away from the ready position.

Preferably, the combustion-type power tool 2 further includes a coupling shank 232 which couples the safety unit 231 to the valve sleeve 22 so as to permit the valve sleeve 22 to move with the safety unit 231.

Preferably, the combustion-type power tool 2 further includes a lever actuating member 4 which extends in a radial direction (Z) from the valve sleeve 22 to terminate at an actuating end 41. As best shown in FIG. 5, the actuating end 41 extends in a transverse direction (Y) transverse to both the longitudinal direction (X) and the radial direction (Z) so as to actuate the power regions 62 of the levers 60 simultaneously when the valve sleeve 22 is displaced from the open position to the close position. More preferably, the lever actuating member 4 and the valve sleeve 22 are formed in one-piece.

When the safety unit 231 is pressed against a workpiece (W) to move from the extended position to a retracted position, the valve sleeve 22 is displaced from the open position to the close position to actuate the power regions 62 of the lever unit 6, the holding member 5 is displaced by the weight regions 63 of the lever unit 6 to move from the normal position to the pressed position, the valve stem 241 is forced into engagement with the intake port 263 of the fuel canister actuator unit 26 by virtue of the displacement of the holding member 5 to place the valve stem 241 in the dispensing position, and the measured dose of fuel is dispensed from the fuel canister 24 and is delivered to the combustion chamber 210 through the intake port 253.

While the present invention has been described in connection with what are considered the most practical and preferred embodiment, it is understood that this invention is not limited to the disclosed embodiment but is intended to cover various arrangements included within the spirit and scope of the broadest interpretations and equivalent arrangements.

What is claimed is:

1. A combustion-type power tool for use with a fuel canister which extends along a lengthwise axis to terminate at a bottom end and a top end, and which has a valve stem that extends along the lengthwise axis and that is movable relative to the top end between a dispensing position, where a measured dose of fuel is dispensed, and a non-dispensing position, said combustion-type power tool comprising:
a housing body defining a main chamber which extends in a longitudinal direction to terminate at a nose end and a head end;
a cylinder disposed in said main chamber, having a cylinder axis in the longitudinal direction, and defining a combustion chamber;
a valve sleeve sleeved on said cylinder and movable relative to said cylinder between an open position, where said combustion chamber is opened, and a close position, where said combustion chamber is closed, said valve sleeve having a nose-side end and a head-side end;
a safety unit configured to be coupled to and moved with said valve sleeve such that when said safety unit is pressed against a workpiece to move from an extended position to a retracted position, said valve sleeve is displaced from the open position to the close position;
a holding member having a base, disposed proximate to said nose-side end, and movable relative to said cylinder between a normal position, where said base is remote from said head end, and a pressed position, where said base is close to said head end, said base being adapted for detachable placement of the fuel canister thereon such that when said holding member is displaced from the normal position to the pressed position, the valve stem is displaced from the non-dispensing position to the dispensing position;
a fuel canister actuator unit pivotally mounted to said housing body proximate to said head end; and
a lever unit including at least one lever which has a power region and a weight region, said lever unit being disposed such that said power region is actuated by displacement of said valve sleeve from the open position toward the close position to permit said weight region to displace said holding member from the normal position to the pressed position so as to force the valve stem into engagement with said fuel canister actuator unit, thereby permitting the measured dose of fuel to be delivered to said combustion chamber through said fuel canister actuator unit.

2. The combustion-type power tool of claim 1, further comprising a lever actuating member which extends in a radial direction from said valve sleeve to terminate at an actuating end which is configured to actuate said power region when said valve sleeve is displaced from the open position to the close position.

3. The combustion-type power tool of claim 1, wherein said holding member defines a central axis substantially parallel to the cylinder axis, and said base is oriented normal to the central axis such that when the fuel canister is disposed on said base, the lengthwise axis is in line with the central axis.

4. The combustion-type power tool of claim 3, wherein said fuel canister actuator unit includes a pivoted end pivotally mounted to said housing body proximate to said head end, and an intake end which has an intake port defining a port axis and which is angularly movable between a clear position, where the fuel canister is removable from or placeable on said base, and a ready position, where the port axis is in line with the lengthwise axis such that when said holding member is displaced from the normal position to the pressed position, said intake port is brought into pressing engagement with the valve stem to place the valve stem in the dispensing position, thereby delivering the measured dose of fuel to said combustion chamber through said intake port.

5. The combustion-type power tool of claim 4, wherein said housing body further defines a canister chamber extending in the longitudinal direction for receiving the fuel canister and said holding member.

6. The combustion-type power tool of claim 5, wherein said housing body is formed with an access opening for providing access to said fuel canister actuator unit, said combustion-type power tool further comprising a fuel canister door which is pivotally mounted to said housing body to be angularly movable between a locked position, where said access opening is closed by said fuel canister door, and an unlocked position, said fuel canister door being configured such that in the locked position, said fuel canister door is brought into pressing engagement with said fuel canister actuator unit to thereby prevent movement of said intake end away from the ready position.

7. The combustion-type power tool of claim 5, wherein said lever unit is disposed in the canister chamber and is pivotally connected to said housing body.

8. The combustion-type power tool of claim 3, wherein said lever unit includes a pair of said levers, which are disposed at opposite sides of the fuel canister in terms of the central axis.

9. The combustion-type power tool of claim 8, wherein said holding member further has a tubular wall extending upwardly from a periphery of said base, said base and said tubular wall cooperatively defining a socket cavity configured to receive the fuel canister fittingly therein.

10. The combustion-type power tool of claim 9, wherein said holding member further has two arms extending respectively from the opposite sides of said base to terminate respectively at two actuated ends, each of said actuated ends being disposed upwardly of said tubular wall and configured to be actuated by said weight region of a corresponding one of said levers so as to permit movement of said holding member from the normal position to the pressed position.

11. The combustion-type power tool of claim 10, further comprising a lever actuating member which extends in a radial direction from said valve sleeve to terminate at an actuating end which extends in a transverse direction transverse to both the longitudinal direction and the radial direction so as to actuate said power regions of said levers simultaneously when said valve sleeve is displaced from the open position to the close position.

12. The combustion-type power tool of claim 1, wherein said lever extends lengthwise to terminate at a sleeve-side end which serves as said power region, and a fulcrum end which is pivotally mounted to said housing body, said weight region being disposed between said sleeve-side end and said fulcrum end.

13. The combustion-type power tool of claim 1, further comprising a coupling shank which couples said safety unit to said valve sleeve so as to permit said valve sleeve to move with said safety unit.
